(19) United States
(12) Patent Application Publication
(10) Pub. No.: US 2026/0254640 A1
(43) Pub. Date: Aug. 27, 2026

(54) SECURE ACCESS SERVICE EDGE FOR PRIVATE APN CUSTOMERS

(71) Applicant: T-Mobile USA, Inc., Bellevue, WA (US)

(72) Inventors: Anis Adil Anis, Bay Point, CA (US); Cristian Asandului, Snoqualmie, WA (US); Nancy L. Atkinson, Raymore, MO (US); Brent Johnston, Ardmore, AL (US); Richard G. Ross, Kingsville, MO (US); Ken S. Walker, Olathe, KS (US); Nathan P. Wilhoft, Shawnee, KS (US)

(21) Appl. No.: 19/061,789

(22) Filed: Feb. 24, 2025

(51) Int. Cl. H04L 9/32

(52) U.S. Cl. CPC H04L 9/32

(57) ABSTRACT

A wireless telecommunications network receives a request from a user equipment (UE) to access a secure access service edge (SASE) service. The UE is configured to receive a private access point name (PAPN) service from the wireless telecommunications network. The wireless telecommunications network authenticates the UE based on an access identifier associated with the UE. Upon successfully authenticating the UE, the wireless telecommunications network transmits information to a SASE server to establish an encrypted connection between the UE and the SASE server. Upon establishment of the encrypted connection, the UE is enabled to perform direct communications with the SASE server without going through a core network of the wireless telecommunications network.

### BACKGROUND

Secure access service edge (SASE) (also referred to as secure access secure edge) is a technology used to deliver wide area network (WAN) and security controls as a cloud computing service directly to the source of a connection (user, device, Internet of Things (IoT) device, or edge computing location) rather than to a data center. SASE uses cloud and edge computing technologies to reduce the latency that results from backhauling all WAN traffic over long distances to one or a few corporate data centers, due to the increased movement off-premises of dispersed users and their applications. This also helps organizations support dispersed users.

An access point name (APN) is a type of identifier that allows a mobile network operator to define which network a connected device is trying to access before making a data connection to it. Additionally, an APN can provide information on the operator's domain network and where it is located. APNs are used by operators of wireless telecommunications networks to control the data connection types, security certificates, and internet protocol (IP) addresses used by the connecting device. A private APN (PAPN) allows a mobile device to enter an IP network but with added security and control for IoT applications. A PAPN segregates traffic on the network from other APNs using custom parameters, which provides the operator more control over security, authentication methods, general network usage, and IP addressing.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a network diagram of a system in which at least some aspects of the disclosed technology are implemented.

FIG. 4 is a system diagram of a system in which at least some aspects of the disclosed technology are implemented.

FIG. 5 is a flowchart of a process in which at least some aspects of the disclosed technology are implemented.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to providing a secure access service edge (SASE) service to private access point name (PAPN) customers of a wireless telecommunications network. In some implementations of the disclosed technology, a SASE service provider connects directly to the customer's data center utilizing an internet protocol security (IPsec) tunnel. In some implementations, a connection between an end user's user equipment (UE) and the customer's data center is established without routing traffic through a core network of the wireless telecommunications network, ensuring secure and efficient data transmission and enhanced security features for PAPN customers. In some implementations of the disclosed technology, the SASE service provider connects to a customer's data center via a cloud peering service, which further enables the SASE service provider to similarly connect to data centers of multiple customers. The system can be configured to, upon the UE initiating a request to connect to a customer's data center, establish an end-to-end encrypted connection between the UE and the customer's data center via the SASE service provider and the cloud peering service, when available, and transfer data between the UE and the customer's data center without routing the data through a core network of the wireless telecommunications network. Doing so enables more secure, efficient, and lower-latency communication between the UE and the customer's data center.

Implementing at least some aspects of the disclosed technology can provide a multitude of benefits such as cost savings, enhanced user experience, network deployment and service offering flexibility, improved compliance, and futureproofing of the SASE service offering. For example, by reducing the need for multiple intermediaries and streamlining the connection process, the disclosed technology can lead to significant cost savings for PAPN customers. A direct connection from the UE to the customer's data center can reduce the complexity and associated costs of managing multiple network connections. User experience can be enhanced by enabling an end user to access applications and services provided by the customer of the wireless telecommunications network more quickly and reliably, leading to increased customer satisfaction. In terms of flexibility, PAPN customers can easily add or remove connections as needed, allowing them to adapt to changing business requirements without significant disruptions. On the topic of improved compliance, adherence to industry standards and regulations by the disclosed technology can ensure that PAPN customers can maintain compliance with data security and privacy requirements, which can reduce the risk of regulatory penalties and enhance the overall security posture of the organization. In terms of futureproofing the SASE service offering, the modular design and scalability of the disclosed technology can allow PAPN customers to easily integrate new technologies and adapt to evolving security threats. This can ensure that the solution remains relevant and effective in the long term.

The disclosed technology can be implemented to support various use cases. In one example, the disclosed technology can be used in the field of providing enterprise connectivity. Large enterprises with multiple branch offices can use the technology disclosed herein to securely connect their branch offices to the central data center. The direct IPsec tunnel can ensure secure and efficient data transmission between the branch offices and the central data center. In another example, the disclosed technology can be implemented to support a remote workforce. Companies with remote workforces can use the disclosed technology to provide secure access to corporate resources for their remote employees. The IPsec tunnel can ensure that remote employees can securely access the company's data center from any location. In yet another example, the disclosed technology can be implemented to support IoT deployments. The disclosed technology can be used to securely connect IoT devices to the central data center. The direct IPsec tunnel ensures that data transmitted from the IoT devices to the data center is secure and protected from unauthorized access.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

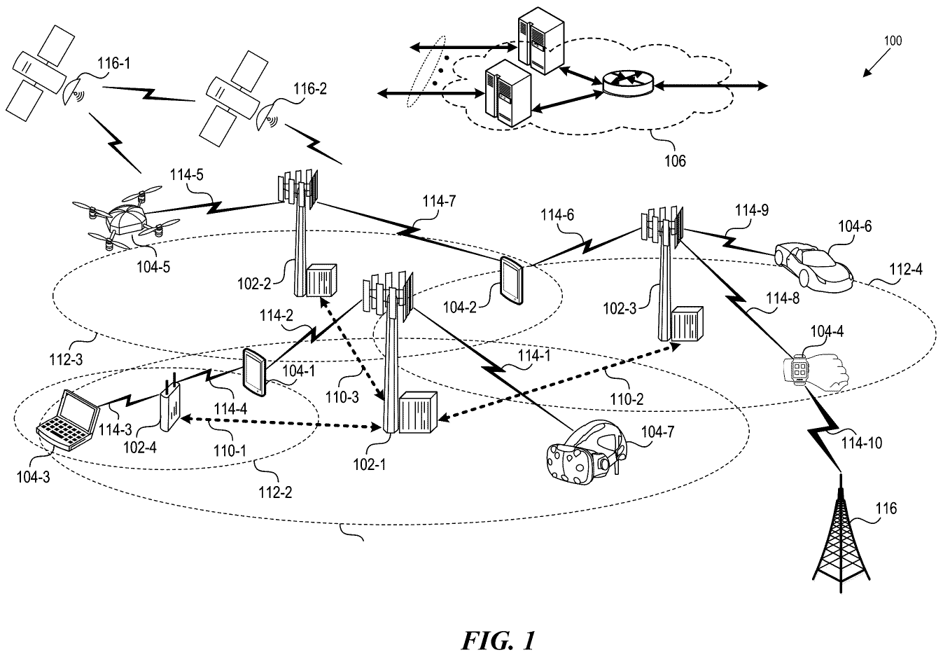

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. In some implementations, a 5G communication channel can use access frequencies of 24 GHz or more. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

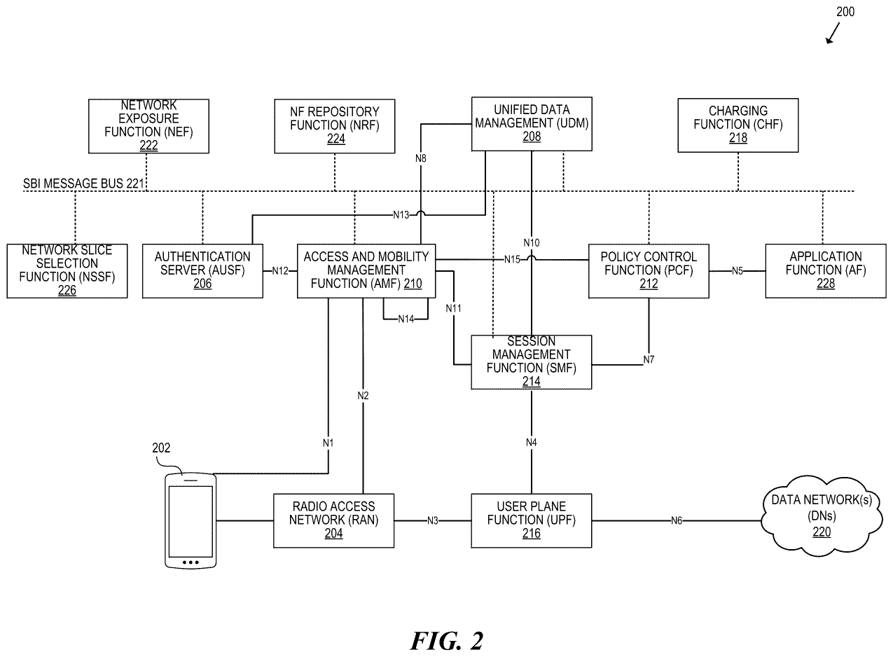

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Providing SASE Service for Private APN Customers

With an increasing demand for secure and reliable network services, there is a need for a solution that offers enhanced security and connectivity for PAPN customers of a wireless telecommunications network. Traditional methods of connecting to customer data centers often involve multiple intermediaries, leading to potential security vulnerabilities and inefficiencies. The technology disclosed herein addresses these challenges by providing a direct and secure connection between a SASE vendor associated with the wireless telecommunications network and the customer's data center. In some implementations, the SASE vendor can establish a direct connection to the customer's data center via an IPsec tunnel that does not involve routing traffic through the wireless telecommunications network's core network, thereby reducing potential security risks and improving data transmission efficiency, which can be beneficial for applications that require real-time data access and low-latency communication. The disclosed technology provides a scalable solution, allowing for easy integration of additional PAPN customers without compromising security or performance. The modular design of the disclosed technology can allow for seamless integration of new customers and expansion of the network infrastructure.

In some implementations, a SASE service provider's infrastructure, such as a server configured to provide SASE service, can be configured to establish a secure IPsec tunnel directly to a data center of the customer of the wireless telecommunications network. In some implementations, establishing the IPsec tunnel can comprise setting up dedicated hardware and software components to manage the IPsec tunnel and ensure its security. In some implementations, establishing the IPsec tunnel outside the wireless telecommunications network, e.g., without routing traffic through the wireless telecommunications network's core network, can ensure that data transmission does not pass through any intermediate networks, thereby reducing the risk of data interception and unauthorized access. In some implementations, the disclosed technology can comprise establishing redundant pathways and failover mechanisms to ensure continuous connectivity and minimize downtime in case of network failures. In some implementations, the SASE service provider can be configured to provide PAPN customers with additional enhanced security features.

In some implementations, upon receiving a connection request from a PAPN customer, a server associated with the SASE service provider can initiate the establishment of an IPsec tunnel. In some implementations, establishment of the IPsec tunnel can include authenticating the UE and configuring the tunnel parameters to match the customer's security requirements. In some implementations, the IPsec tunnel can be configured to provide end-to-end encryption, ensuring that data transmitted between the SASE vendor and the customer's data center remains secure. In some implementations, encryption protocols such as AES-256 can be used to protect user traffic from unauthorized access. In some implementations, the SASE service provider can continuously monitor the IPsec tunnel ingress and egress traffic for any potential security threats, determine a cybersecurity threat level, and take appropriate measures to mitigate those threats. In some implementations, such appropriate measures can include taking at least one action. In some implementations, the at least one action can include, for example, implementing strong authentication mechanisms and encryption protocols, real-time threat detection, intrusion prevention, content filtering, IP address filtering, blocking access to a webpage, or regular security audits to identify and address vulnerabilities. In some implementations, such appropriate measures can further include ensuring compliance with relevant industry standards and regulations such as the European Union's General Data Protection Regulation (GDPR), the Health Insurance Portability and Accountability Act (HIPAA) in the United States, or the payment card industry data security standard (PCI-DSS) to ensure the security and privacy of customer data.

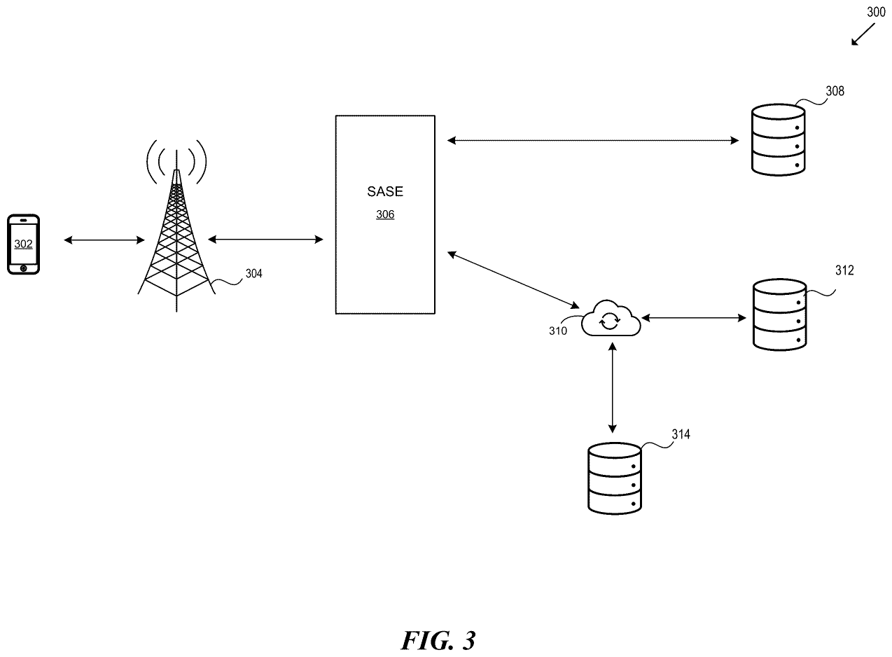

FIG. 3 is a network diagram of a system 300 in which at least some aspects of the disclosed technology are implemented. In some implementations, a UE 302 is associated with a customer of a wireless telecommunications network. In some implementations, the UE 302 can be configured to receive PAPN service from the wireless telecommunications network. In some implementations, the UE 302 can connect to a RAN 304 of the wireless telecommunications network. Not all network elements and network functions of the RAN 304 are shown in FIG. 3. However, a person having ordinary skill in the art will recognize that the RAN 304 of the wireless telecommunications network can include various network elements and functions as described in FIGS. 1 and 2. Further, while a core network of the wireless telecommunications network is not shown in FIG. 3, a person of ordinary skill in the art will recognize that the wireless telecommunications network can include a core network comprising various network elements and functions as described in FIGS. 1 and 2.

In some implementations, the UE 302 can initiate a request via the RAN 304 of the wireless telecommunications network to exchange data with a server 308 of a customer of the wireless telecommunications network. In some implementations, the UE 302 can be authenticated by the wireless telecommunications network based on an access identifier associated with the UE 302. In some implementations, the access identifier can be stored in a subscriber identity module (SIM) of the UE 302. In some implementations, the UE 302 can be configured to exchange data traffic with the server 308 using PAPN service. In some implementations, the UE 302 can be configured to connect to the server 308 to access applications (apps) and services hosted by the server 308 via a SASE server 306 of a SASE service provider, instead of using a traditional virtual private network (VPN) connection. In a normal mode of operation of the wireless telecommunications network without the disclosed technology implemented, the wireless telecommunications network can pass traffic from the UE 302 to the SASE server 306 via the RAN 304 and the wireless telecommunications network's core network (not shown in FIG. 3). The SASE server 306 can apply SASE features to the traffic and send the traffic back to the core network for forwarding to the server 308 of the customer. In some embodiments when the disclosed technology is implemented, the SASE server 306 can be configured to establish an encrypted connection with the customer's server 308. In some implementations, the RAN 304 can be configured to forward data traffic between the UE 302 and the SASE server 306 directly to the SASE server 306 without routing it through the core network. In some implementations, the encrypted connection between the SASE server 306 and the customer's server 308 can include an IPsec tunnel. In some implementations, the IPsec tunnel can comprise one leg of an end-to-end encrypted connection between the UE 302 and the customer's server 308, with an encrypted connection between the UE 302 and the SASE server 306 forming another leg of the end-to-end encrypted connection. In some implementations, the IPsec tunnel can be secured using encryption protocols such as AES-256.

In some implementations, the UE 302 can initiate a request via the RAN 304 of the wireless telecommunications network to exchange data with a server 312 of a customer of the wireless telecommunications network. In some implementations, the UE 302 can be configured to exchange data traffic with the server 312 using PAPN service. In some implementations, the UE 302 can be configured to connect to the server 312 to access applications (apps) and services hosted by the server 312 via a SASE server 306 of a SASE service provider, instead of using a traditional VPN connection. In a normal mode of operation of the wireless telecommunications network without the disclosed technology implemented, the wireless telecommunications network can pass traffic from the UE 302 to the SASE server 306 via the RAN 304 and the wireless telecommunications network's core network (not shown in FIG. 3). The SASE server 306 can apply SASE features to the traffic and send the traffic back to the core network for forwarding to the server 312 of the customer. In some embodiments when the disclosed technology is implemented, the SASE server 306 can be configured to establish an encrypted connection with a server 310 of a cloud peering service provider to which the customer's server 312 is also connected via another encrypted connection. In some implementations, the SASE server 306 can be connected to servers of multiple customers via the cloud peering service server 310. For example, in addition to the customer server 312 of a first customer, the SASE server 306 can be further connected to a customer server 314 of a second customer of the wireless telecommunications network via the cloud peering service server 310. In some implementations, the RAN 304 can be configured to forward data traffic between the UE 302 and the SASE server 306 directly to the SASE server 306 without routing it through the core network. In some implementations, the encrypted connection between the SASE server 306 and the cloud peering service server 310, and the encrypted connection between the cloud peering service server 310 and the customer server 312, can each include an IPsec tunnel. In some implementations, each of the IPsec tunnels can comprise one leg of an end-to-end encrypted connection between the UE 302 and the customer server 312, with an encrypted connection between the UE 302 and the SASE server 306 forming another leg of the end-to-end encrypted connection. In some implementations, the IPsec tunnel can be secured using encryption protocols such as AES-256.

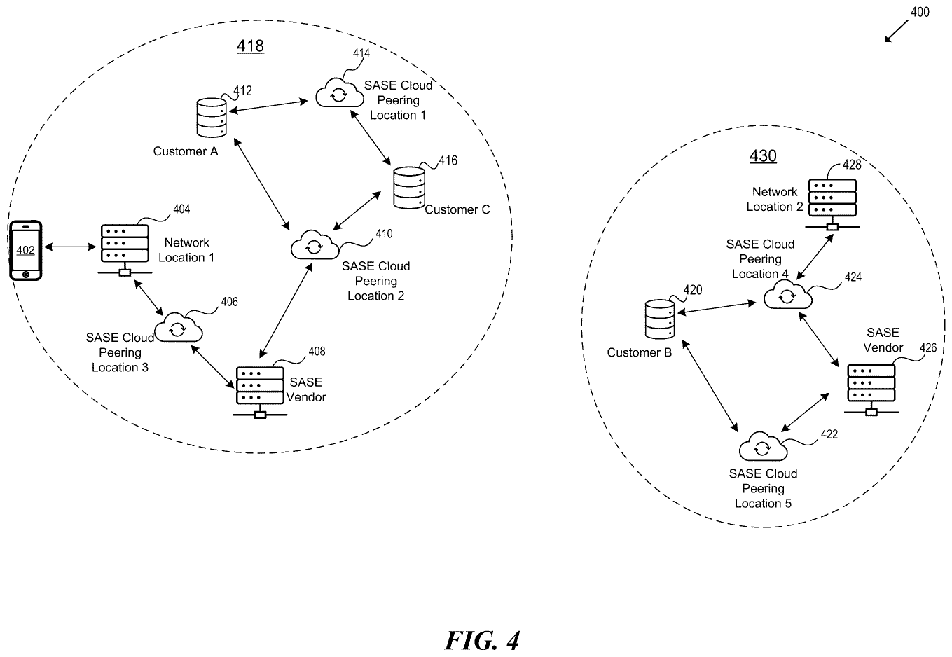

FIG. 4 is a system diagram of a system 400 in which at least some aspects of the disclosed technology are implemented. In some implementations, the disclosed technology can be implemented in a single geographical region 418 of the wireless telecommunications network. In some implementations, the disclosed technology can be implemented in multiple geographical regions, for example, region 418 and region 430, of the wireless telecommunications network. The wireless telecommunications network can include one or more network locations, for example, network location 1 (404), which hosts various network elements and network functions serving geographical region 418, and network location 2 (428), which hosts various network elements and network functions serving geographical region 430. For example, each of network location 1 (404) and network location 2 (428) can host various network elements and network functions associated with the RAN and/or core network of the wireless telecommunications network as described in FIG. 1 or FIG. 2.

In some implementations, in geographical region 418, network location 1 (404) of the wireless telecommunications network can be connected to a SASE vendor server 408 via SASE cloud peering location 3 (406). In some implementations, the SASE vendor server 408 can further be connected to SASE cloud peering location 2 (410), through which it is further connected to servers of multiple customers, for example, a server 412 of customer A and a server 416 of customer C. In some implementations, the servers 412 and 416 can have multiple connections to the SASE vendor server 408. For example, the server 412 of customer A can have a primary connection to the SASE vendor server 408 via SASE cloud peering location 1 (414) and a backup connection to the SASE vendor server 408 via SASE cloud peering location 2 (410). Similarly, the server 416 of customer C can have a primary connection to the SASE vendor server 408 via SASE cloud peering location 2 (410) and a backup connection to the SASE vendor server 408 via SASE cloud peering location 1 (414).

In some implementations, in geographical region 430, network location 2 (428) of the wireless telecommunications network can be connected to a SASE vendor server 426 via SASE cloud peering location 4 (424). In some implementations, a server 420 of customer B can be connected to the SASE vendor server 426 via multiple connections, for example, a primary connection via SASE cloud peering location 4 (424) and a backup connection via SASE cloud peering location 5 (422). In some implementations, the SASE vendor servers 408 and 426 can be connected to each other (not shown in FIG. 4) and be configured to serve a UE 402 when the UE is in their respective geographical region. For example, when the UE 402 is located in geographical region 418 and initiates a request to communicate with the server 412 of customer A, the request can be processed by the SASE vendor server 408. On the other hand, when the UE 402 is located in geographical region 430 and initiates a request to connect to communicate with the server 412 of customer A, the request can be processed by the SASE vendor server 426.

In some implementations, the UE 402 can initiate a request via network location 1 (404) of the wireless telecommunications network to exchange data with the server 412 of customer A. In some implementations, the UE 402 can be configured to exchange data traffic with the server 412 using PAPN service. In some implementations, the UE 402 can be configured to connect to the server 412 to access applications (apps) and services hosted by the server 412 of customer A via the SASE vendor server 408, instead of using a traditional virtual private network (VPN) connection. In a normal mode of operation of the wireless telecommunications network without the disclosed technology implemented, network location 1 (404) of the wireless telecommunications network can pass traffic from the UE 402 to the SASE vendor server 408 via the wireless telecommunications network's RAN and core network. The SASE vendor server 408 can apply SASE features to the traffic and send the traffic back to the core network for forwarding to the server 412 of customer A. In some embodiments when the disclosed technology is implemented, the SASE vendor server 408 can be configured to establish an encrypted connection with SASE cloud peering location 2 (410), to which customer A's server 412 is also connected, via another encrypted connection. In some implementations, the encrypted connection between the SASE vendor server 408 and SASE cloud peering location 2 (410), and the encrypted connection between SASE cloud peering location 2 (410) and the customer server 412, can each include an IPsec tunnel. In some implementations, each of the IPsec tunnels can comprise one leg of an end-to-end encrypted connection between the UE 402 and customer A's server 412, with an encrypted connection between the UE 402 and the SASE vendor server 408 forming another leg of the end-to-end encrypted connection. In some implementations, the IPsec tunnel can be secured using encryption protocols such as AES-256.

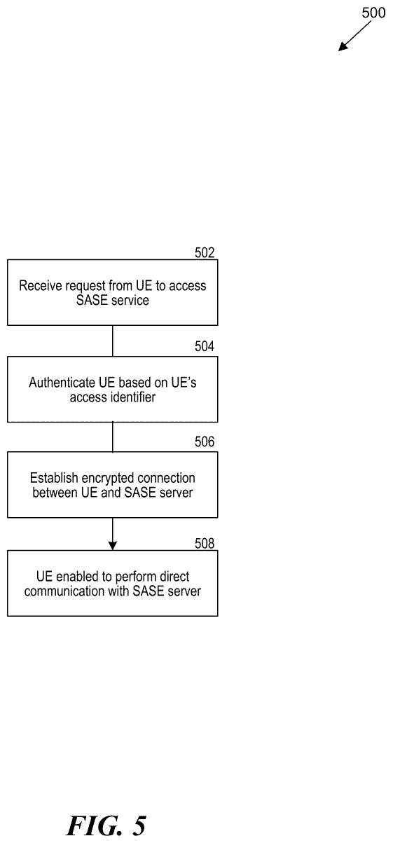

FIG. 5 is a flowchart of a process 500 in which at least some aspects of the disclosed technology are implemented. At 502, a wireless telecommunications network can receive a request from a UE to access a SASE service. In some implementations, the UE can be configured to receive a PAPN service from the wireless telecommunications network. At 504, the UE can be authenticated by the wireless telecommunications network based on an access identifier associated with the UE. In some implementations, the access identifier can be stored in a SIM of the UE. At 506, upon the wireless telecommunications network successfully authenticating the UE, the wireless telecommunications network can transmit information to a server associated with the SASE service to establish an encrypted connection between the UE and the server associated with the SASE service. In some implementations, the server associated with the SASE service can be a first server associated with the SASE service when the UE is connected to the wireless telecommunications network from a first location, and the server associated with the SASE service can be a second server associated with the SASE service when the UE is connected to the wireless telecommunications network from a second location. In some implementations, the encrypted connection between the UE and the server associated with the SASE service can comprise a first leg of an end-to-end encrypted connection between the UE and a server of a customer of the wireless telecommunications network. In some implementations, the end-to-end encrypted connection between the UE and the server of the customer of the wireless telecommunications network can comprise an internet protocol security (IPsec) tunnel between the UE and the server of the customer. In some implementations, the IPsec tunnel can be encrypted based on AES-256 encryption protocol. At 508, upon establishment of the encrypted connection, the UE can be enabled to perform direct communications with the server associated with the SASE service without going through a core network of the wireless telecommunications network.

### Computer System

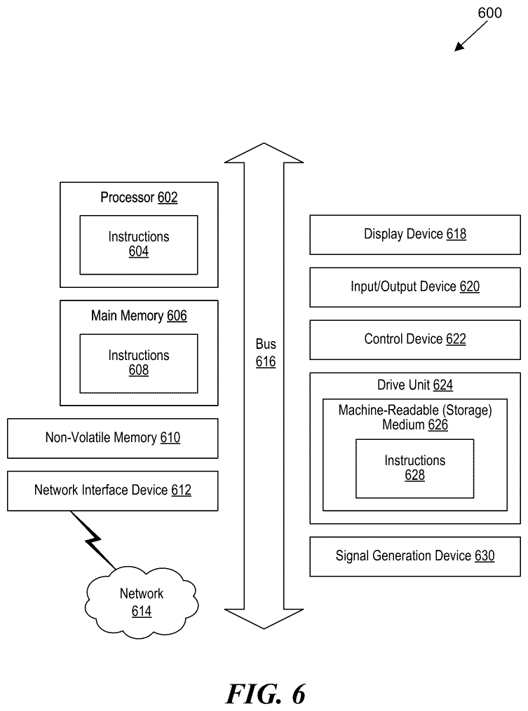

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A method comprising:
receiving, by a wireless telecommunications network, a request from a user equipment (UE) to access a secure access service edge (SASE) service,
wherein the UE is configured to receive a private access point name (PAPN) service from the wireless telecommunications network;
authenticating the UE by the wireless telecommunications network based on an access identifier associated with the UE; and
transmitting, upon the wireless telecommunications network successfully authenticating the UE, information to a server associated with the SASE service to establish an encrypted connection between the UE and the server associated with the SASE service,
wherein, upon establishment of the encrypted connection, the UE is enabled to perform direct communications with the server associated with the SASE service without going through a core network of the wireless telecommunications network.

2. The method of claim 1,
wherein the access identifier is stored in a subscriber identity module (SIM) of the UE.

3. The method of claim 1,
wherein the encrypted connection between the UE and the server associated with the SASE service comprises a first leg of an end-to-end encrypted connection between the UE and a server of a customer of the wireless telecommunications network.

4. The method of claim 3,
wherein the end-to-end encrypted connection between the UE and the server of the customer of the wireless telecommunications network comprises an internet protocol security (IPsec) tunnel between the UE and the server of the customer.

5. The method of claim 4 wherein the IPsec tunnel is encrypted based on AES-256 encryption protocol.

6. The method of claim 1,
wherein the server associated with the SASE service is a first server associated with the SASE service when the UE is connected to the wireless telecommunications network from a first location, and
wherein the server associated with the SASE service is a second server associated with the SASE service when the UE is connected to the wireless telecommunications network from a second location.

7. A method comprising:
maintaining, by a first server associated with a secure access service edge (SASE) service, data related to a user of a wireless telecommunications network;
receiving, by a second server associated with the SASE service, a request from the wireless telecommunications network,
wherein the request is configured to establish an encrypted connection between a user equipment (UE) of the user and the second server;
establishing, by the second server, a first encrypted connection with the UE;
retrieving, by the second server, the data related to the user from the first server associated with the SASE service; and
performing, by the second server, a transmission with the UE without going through a core network of the wireless telecommunications network.

8. The method of claim 7,
wherein the first server and the second server are located in different geographical locations.

9. The method of claim 7,
wherein the UE is authenticated by the wireless telecommunications network based on an access identifier associated with the UE, and
wherein the access identifier is stored in a subscriber identity module (SIM) of the UE.

10. The method of claim 7,
wherein the request is associated with receiving a private access point name (PAPN) service from the wireless telecommunications network.

11. The method of claim 7, wherein establishing the first encrypted connection with the UE by the second server further comprises:
establishing an internet protocol security (IPsec) tunnel between the UE and the second server.

12. The method of claim 11 wherein the IPsec tunnel is encrypted based on AES-256 encryption protocol.

13. The method of claim 11 wherein the IPsec tunnel between the UE and the second server comprises a first leg of an end-to-end encrypted connection between the UE and a server of a customer of the wireless telecommunications network.

14. The method of claim 7, further comprising:
establishing, by the second server, a second encrypted connection with a server associated with a cloud peering service,
wherein the second encrypted connection between the second server and the server associated with the cloud peering service comprises a second leg of an end-to-end encrypted connection between the UE and a server of a customer of the wireless telecommunications network.

15. The method of claim 7, further comprising:
determining a cybersecurity threat level of the transmission between the UE and the second server; and
performing at least one action based on the determining to secure the transmission between the UE and the second server,
wherein the performing the at least one action includes content filtering, internet protocol (IP) address filtering, or blocking access to a webpage.

16. A user equipment (UE) configured to receive a private access point name (PAPN) service from a wireless telecommunications network, the UE comprising:
at least one hardware processor; and
at least one non-transitory memory storing instructions, which, when executed by the at least one hardware processor, cause the UE to:
send, to a wireless telecommunications network, a request to access a secure access service edge (SASE) service, the request comprising an access identifier of the UE,
establish, upon successful authentication of the UE by the wireless telecommunications network, an encrypted connection between the UE and a server associated with the SASE service, and
upon establishing the encrypted connection, perform direct communications with the server associated with the SASE service without going through a core network of the wireless telecommunications network.

17. The UE of claim 16,
wherein the access identifier is stored in a subscriber identity module (SIM) of the UE.

18. The UE of claim 16,
wherein the encrypted connection between the UE and the server associated with the SASE service comprises a first leg of an end-to-end encrypted connection between the UE and a server of a customer of the wireless telecommunications network.

19. The UE of claim 18,
wherein the end-to-end encrypted connection between the UE and the server of the customer of the wireless telecommunications network comprises an internet protocol security (IPsec) tunnel between the UE and the server of the customer.

20. The UE of claim 16,
wherein the server associated with the SASE service is a first server associated with the SASE service when the UE is connected to the wireless telecommunications network from a first location, and
wherein the server associated with the SASE service is a second server associated with the SASE service when the UE is connected to the wireless telecommunications network from a second location.
